(19) United States
(12) Patent Application Publication
(10) Pub. No.: US 2025/0185641 A1
(43) Pub. Date: Jun. 12, 2025

(54) Method for an Open-Loop and/or Closed-Loop Control of an Agricultural Distribution Machine and Agricultural Distribution Machine

(71) Applicant: Amazonen-Werke H. Dreyer SE & Co. KG, Hasbergen (DE)

(72) Inventor: Markus TRENTMANN, Wallenhorst (DE)

(73) Assignee: Amazonen-Werke H. Dreyer SE & Co. KG, Hasbergen (DE)

(21) Appl. No.: 18/838,860

(22) PCT Filed: Feb. 6, 2023
(86) PCT No.: PCT/EP2023/052785

§ 371 Date: Aug. 15, 2024

(30) Foreign Application Priority Data
Feb. 16, 2022 (DE) 10 2022 103 567.0

(51) Int. Cl. A01M 7/00; G05D 7/06; G05D 16/20

(52) U.S. Cl. CPC A01M 7/0089; G05D 7/0623; G05D 16/20

(57) ABSTRACT

A method for an open-loop and/or closed-loop control of an agricultural distribution machine, in particular a field sprayer, when spreading liquid distribution material, in which at least one controlled variable, in particular a system pressure and/or a flow rate, is determined and/or predefined for the distribution material, on the basis of which the distribution material is conveyed at least in sections along a liquid circuit formed within the distribution machine, wherein the controlled variable, in particular the system pressure or the flow rate, is adjusted by way of at least one, in particular central, metering and/or actuating element arranged along the liquid circuit. In order to further improve spreading of liquid distribution material using an agricultural distribution machine, it is provided that the distribution machine can be operated with different control strategies, wherein the controlled variable which is adjusted by the at least one, in particular central, metering and/or actuating element, is switched or at least substantially ignored based on the control strategies.

### CROSS REFERENCE TO RELATED APPLICATIONS

The present application claims priority under 35 U.S.C. § 365 to PCT/EP2023/052785 filed on Feb. 6, 2023 and under 35 U.S.C. § 119 (a) to German Application No. 10 2022 103 567.0 filed on Feb. 16, 2022.

### BACKGROUND

The disclosure relates to a method for an open-loop and/or closed-loop control of an agricultural distribution machine and to an agricultural distribution machine.

Towed, carried, and/or self-propelled distribution machines, such as field sprayers, are regularly used to spread liquid distribution material on agricultural land. In dependence of requirements, the distribution material is frequently configured as fertilizer, plant protection agent, weed killer, pesticide or the like and is typically spread or applied by way of a plurality of spreading nozzles, in particular spray nozzles, which are arranged at the distribution machine. In order to provide the distribution material to the respective spreading nozzles as required, an internal machine flow rate of the distribution material is suitably controlled in an open-loop and/or closed-loop manner. The manner in which the flow rate is controlled in an open-loop and/or closed-loop manner differs in dependence of the distribution machine and/or the case of application.

For example, distribution machines are known from prior art in which a predefined and/or determined, in particular central, flow rate of the distribution material is controlled in an open-loop and/or closed-loop manner by way of at least one metering and/or actuating element arranged along a liquid circuit of the distribution machine. In prior art, such a control strategy is often also referred to as central volume flow control, in particular with decentralized pressure control, and is used for relatively large-area spreading with relatively large flow rates or volume flows, respectively.

However, such a control strategy has the disadvantage that, at relatively low flow rates, the detection and therefore also the open-loop and/or closed-loop control of the flow rate is inaccurate. Such a control strategy is therefore rather disadvantageous, in particular, for individual plant treatments and/or when spreading by way of a decreasing or small number of spreading nozzles, such as between converging and/or triangular field boundaries.

In order to counteract the problems described above, distribution machines which control in an open-loop and/or closed-loop manner the distribution material conveyed along the liquid circuit to a predefined and/or determined system pressure by way of the at least one metering and/or actuating element are also used in practice. Such control strategies are often referred to in prior art as central pressure control.

However, such control strategies have so far had the disadvantage that the respective information or properties of the spreading nozzles used, in particular of associated metering and/or actuating elements, must always be known and/or monitored so that the actual spreading quantity can be determined and/or adjusted via the respective, in particular individual, spreading nozzles in dependence of the system pressure. Such information or properties have so far had to be detected and/or provided specifically for the respective spreading nozzles, in particular metering and/or actuating elements, which is particularly complex.

Furthermore, such a control strategy has the disadvantage that, with information or properties detected and/or provided in this way, changes at the respective spreading nozzle, which occur, for example, in the form of aging or wear and affect the flow of the distribution material, are at least almost ignored when determining the flow rate and/or spreading quantity.

### SUMMARY

The object underlying the disclosure is therefore to further improve the spreading of liquid distribution material using an agricultural distribution machine. The object is, in particular, to overcome at least in part the disadvantages mentioned above when spreading the liquid distribution material.

The object is satisfied by a method of the kind mentioned at the outset, where the distribution machine can be operated with different control strategies, and where the controlled variable which is adjusted by at least one, in particular central, metering and/or actuating element is switched or at least substantially ignored based on the control strategies.

It is particularly preferably provided that the distribution material conveyed along the liquid circuit is adjusted to the determined and/or predefined system pressure in a selectable first control strategy and to the determined and/or predefined flow rate in a selectable second control strategy by way of the at least one, in particular central, metering and/or actuating element.

As a result of this measure, the distribution machine can be operated with different control strategies in different situations. It can be provided, in particular, that the distribution machine is operated at least predominantly or during normal operation with one of the several control strategies, e.g. with the first control strategy, during the spreading process and during special operation, such as acceleration, turning maneuvers, spreading in the vicinity of field boundaries, calibration processes, etc. with the respective other control strategy, e.g. with the second control strategy. At least one, in particular central, controlled variable of the closed-loop control can then be adapted and/or switched during operation of the distribution machine. In particular, the open-loop and/or closed-loop control of the distribution machine can thus be converted, for example, between a central volume flow control and a central pressure control. This has the advantage that the open-loop and/or closed-loop control of the distribution machine can be adapted to the situation and is therefore particularly flexible.

Furthermore, when ignoring the controlled variable, it can preferably be provided that the at least one metering and/or actuating element is at least almost completely opened, for example, for a maximum flow rate. The flow, in particular the flow rate, of the distribution material is therefore not controlled in a closed-loop manner and/or adapted by the metering and/or actuating element when spreading in the second control strategy.

In the following, the term “control strategy” is preferably understood to mean a closed-loop control mode of the distribution machine, in particular of the open-loop and/or closed-loop control. It is particularly preferred to have the closed-loop control mode be selected from at least a first and a second closed-loop control mode which particularly preferably correspond to a first and second control strategy.

The control strategy of the distribution machine can be converted as described above during the spreading process, in particular, when traveling across the agricultural area. It is furthermore provided that the control strategy is alternatively or additionally converted and/or changed in advance or prior to spreading the distribution material, for example, at least temporarily on a test area provided for this purpose and/or in a workshop or the like.

The at least one metering and/or actuating element arranged along the liquid circuit is preferably configured in the manner of an adjustment valve and is configured to influence and/or adjust the system pressure and/or the flow rate of the distribution material through the liquid circuit. A flow resistance and/or an opening or flow cross-section for the distribution material is particularly preferred adjusted by way of the metering and/or actuating element. A distribution machine which comprises several such, in particular central, metering and/or actuating elements along the liquid circuit, for example, at a supply and a return line, is also preferred.

In a preferred embodiment of the method according to the disclosure, a spreading quantity with which the distribution material is spread, preferably as needed and/or nozzle by nozzle, via the spreading nozzles, in particular the spray nozzles, is first determined and/or predefined. Furthermore, one or more metering and/or actuating elements are associate with several or each of the spreading nozzles by way of which, in particular additionally, the flow rate is controlled in an open-loop and/or closed-loop manner in the first control strategy and the system pressure in the second control strategy. According thereto, at least one of the control strategies preferably has several closed-loop control circuits for conveying the distribution material, where the, in particular central, metering and/or actuating element is controlled in a closed-loop manner as the first controlled variable in a first closed-loop control circuit and the metering and/or actuating elements, in particular being specific to the spray nozzle, are controlled in an open-loop manner as the second controlled variable in a second closed-loop control circuit. In other words, it can there be provided, for example, that in the second control strategy, the defined flow rate is controlled in a closed-loop manner and/or adjusted by way of the first controlled variable and the defined system pressure by way of the second controlled variable and therefore by way of the individual metering and/or switching elements. This example results in central volume flow control with decentralized system pressure control. Alternatively or additionally, the open-loop control circuits and therefore also the controlled variables for the first control strategy can be exchanged for one another, which in turn corresponds to central system pressure control with decentralized volume flow control. With a method that controls in a closed-loop manner and/or adjusts the flow of the distribution material by way of several closed-loop control circuits, the spreading of the distribution material can be adjusted with particularly high accuracy.

The metering and/or actuating elements are preferably configured in the form of switching valves which are each associated with a single spreading nozzle or alternatively with several spreading nozzles at the same time. Such metering and/or actuating elements are particularly preferably configured as PWM and/or PWFM valves. Alternatively, such metering and/or actuating elements can also be configured as adjustment valves which are configured to adapt and/or adjust the respective spreading quantity of a spreading nozzle and/or of several or a group of spreading nozzles. Such metering and/or actuating elements are particularly preferably arranged immediately upstream of the spreading nozzles, in particular spray nozzles, so that, in particular the second controlled variable is controlled (in dependence of the control strategy for the system pressure or the flow rate) in an open-loop and/or closed-loop manner immediately upstream of the spreading nozzles, in particular the spray nozzles.

In addition, the spreading nozzle is preferably arranged on a spray boom of the distribution machine, in particular one that is mounted in a pendulum manner and/or is height-controlled. The spreading nozzles are also preferably configured in the manner of a nozzle body with at least one spray nozzle. Alternatively or additionally, the spreading nozzles configured as multiple nozzle bodies is also conceivable, where each of them comprises several, in particular selectable and/or switchable, spray nozzles which preferably differ in the size of the outlet opening or of a nozzle caliber. Spreading nozzles with nozzle bodies in which at least one of the metering and/or actuating elements is integrated are furthermore preferred.

According to the disclosure, the term “spreading quantity” is preferably to be understood as the quantity of the distribution material actually spread or to be spread from and/or applied or to be applied by the distribution machine. The spreading quantity is preferably a predefined target value which reflects the actual need for distribution material on the agricultural area and/or the plant population thereon, in particular of the crops or weeds. The spreading quantity is particularly preferably predefined manually by an operator and/or in an automated manner using an electronically stored map, in particular an application map, for example, in volume per area such as liters per hectare.

In a further development of the method according to the disclosure, the flow rate is detected by way of at least one measuring device that is arranged, in particular along the liquid circuit. The at least one measuring device is preferably arranged centrally along the liquid circuit and is particularly suitable for detecting the flow rate of the distribution material through the liquid circuit. The measuring device particularly preferably comprises one or more flow rate sensors which are configured, in particular in the manner of volume flow sensors or alternatively or additionally as pressure sensors. Furthermore, it is preferably provided that adjustment parameters, that are, in particular, valve-specific, are determined and/or detected and are adjusted in the second control strategy in dependence of the system pressure on the respective metering and/or actuating elements. The respective adjustment parameters of the metering and/or actuating elements are selected and/or adjusted such that the predefined system pressure of the distribution material within the liquid circuit is set and/or reached. It is provided, in particular, that the distribution machine is operated in the second control strategy and the flow rate of the distribution material is therefore adjusted by way of the metering and/or actuating element, while in parallel or at the same time, the system pressure is controlled in a closed-loop manner, adjusted, and/or at least kept substantially constant by way of the adjustment parameters of the individual metering and/or actuating elements. The system pressure is there preferably detected and/or adjusted such that the respective adjustment parameters of the metering and/or actuating element can be associated with the respective spreading nozzle and determined and/or recorded in relation to the respective system pressure. Such adjustment parameters can be, for example, a switching frequency, a degree of opening, and/or a duration of the opening of the metering and/or actuating element. In particular, such adjustment parameters can also be a pulse width and/or a pulse frequency or a duty cycle of a metering and/or actuating element formed as a PWM (PWFM) valve. In a preferred further step, one or more relationships related to the system pressure are determined between the flow rate and the respective, in particular valve-specific, adjustment parameters. In other words, it is preferably ascertained and/or defined with which adjustment parameters which flow rate, in particular spreading quantity, is achieved through a respective spreading nozzle at a certain system pressure.

In another preferred embodiment of the method according to the disclosure, the one or more relationships are determined for each spreading nozzle based on the flow rate and the number of spreading nozzles, preferably nozzle by nozzle and/or individually. The flow rate which is detected, in particular centrally, is preferably allocated at least in part among the several spreading nozzles or standardized to a single spreading nozzle. While the second control strategy is active and the adjustment parameters of the spreading nozzles are detected, the distribution material is preferably spread via a plurality of spreading nozzles or each of the spreading nozzles. The accuracy of the spreading process is further improved with such an embodiment. Alternatively, it would also be conceivable to limit the number of activated spreading nozzles in the second control strategy. For example, it would be conceivable that during the second control strategy only every second or third spreading nozzle or at least one spreading nozzle of a kind and/or of each group is activated or opened for spreading the distribution material. This allows particularly efficient determination of the adjustment parameters required for a defined flow rate, in a particular a spreading quantity.

In another further development of the method according to the disclosure, the metering and/or actuating elements, in particular the spreading quantities, are set in the first control strategy in dependence and/or on the basis of the one or more adjustment parameters and/or relationships determined in the second control strategy. The adjustment parameters set in a preceding step or during the second control strategy and then recorded in the process are retrieved in a subsequent step or in the first control strategy for adjusting the required spreading quantity and/or are predefined for the respective metering and/or actuating element. In other words, the adjustments and/or parameterizations of the respective metering and/or actuating elements in the first control strategy are carried out on the basis of the adjustment parameters detected and/or ascertained during the second control strategy or the detected and/or ascertained relationships, respectively. For and/or during the first control strategy, it is preferably provided that a defined system pressure is predefined and is adjusted by way of the, in particular central, metering and/or actuating element. The respective metering and/or actuating elements of the individual spreading nozzles are there particularly preferably adjusted based on the spreading quantities retrieved and/or predefined and the adjustment parameters previously ascertained in the second control strategy or the corresponding relationships of the system pressure and the flow rate. This embodiment has the decisive advantage that, for spreading the distribution material, information and/or properties, such as fluid properties of the distribution material (viscosity, etc.) and/or valve and/or nozzle properties, of the metering and/or actuating elements and/or the spreading nozzles can be neglected at least substantially, thus achieving a particularly simple method and/or simple distribution machine.

It is preferably provided that the system pressure is entered and/or predefined manually by an operator, for example, using a mobile control and/or display device. Alternatively or additionally, the system pressure can also be retrieved by way of an electronically stored map, in particular an application map and/or in a partial area-specific manner. In addition, the system pressure can preferably be predefined in the form of an individual value, for example 3 bar, or alternatively in the form of range or acceptance limits, for example, 2.8 to 3.0 bar.

In a further preferred embodiment of the method according to the disclosure, the metering and/or actuating elements are configured to release the distribution material in a pulse width modulated manner. The at least one adjustment parameter of the metering and/or actuating elements is there configured as a pulse width and/or pulse frequency, preferably as a duty cycle. In particular, it is provided that during the second control strategy, the respective relationship for the metering and/or actuating element related to the system pressure is formed from the defined or detected flow rate and the pulse width set, in particular the duty cycle. It is particularly preferably provided that for a defined first system pressure, e.g. 3 bar or 2.8 to 3.0 bar, a first relationship of the flow rate and the pulse width, in particular the duty cycle is detected and/or determined, and for a defined second system pressure, e.g. 2.5 bar or 2.3 to 2.5 bar, a second relationship of the flow rate and the pulse width, in particular a duty cycle. It would also be conceivable that, from several detected and/or determined relationships, further relationships are calculated and/or determined analytically and/or using a generated function curve, e.g. in the manner of an interpolation or the like.

In a further development of the method according to the disclosure, the control strategy of the distribution machine is changed preferably once or several times before and/or during the spreading process of the distribution material from the first control strategy to the second control strategy. Once the adjustment parameters and/or relationships needed, in particular, for a predefined and/or required system pressure, are detected and/or recorded within the second control strategy, the first control strategy is adjusted at the distribution machine for spreading the distribution material. It can be provided, in particular, that the second control strategy is switched on and/or activated outside of the agricultural area actually to be applied. For example, it can be provided that the control strategy is changed as part of a calibration process and/or test operation on an operator's farm and/or at the manufacturer's premises. Alternatively or additionally, it can be provided that the control strategy is adapted at least briefly at the edge of a field and/or on a headland. In addition, it would also be conceivable that the control strategy is changed at least temporarily when the distribution material is spread on the agricultural area. It can be provided, in particular, that the second control strategy is switched on or activated, preferably in an automated manner, until a sufficient number and/or quantity of adjustment parameters and/or relationships is detected and/or recorded.

In a particularly preferred embodiment in which the distribution machine is adjusted by way of spreading nozzles to spread the distribution material in a location-specific or partial area-specific manner, in particular in a point-specific manner, it is provided that the distribution machine is generally or at least almost predominantly operated with the first control strategy. The control strategy of the distribution machine is preferably changed and/or switched to calibrate and/or teach the adjustment parameters. The control strategy is therefore temporarily changed and/or switched to the second control strategy at least briefly for detecting and/or determining the adjustment parameters for the first control strategy.

In addition, a method according to the disclosure is preferred in which the control strategy is changed after a change in the operating state of the distribution machine and/or an exceedance or undershoot of defined flow values for the distribution material conveyed, for example, a limit value for the system pressure. A change in the operating state can be caused, for example, by switching a determined, in particular predefined, number of spreading nozzles on and/or off. Alternatively or additionally, a change in the operating state can also be caused by exchanging spreading nozzles, in particular, if the spraying properties and/or the size of the spreading openings or the nozzle calibers of the exchanged spreading nozzles differ. In addition, adjustment of the control strategy, at least briefly, can be required if, for example, defined ranges for the system pressure, in particular, those to be set, are exceeded or undershot. Other flow values, such as the flow rate or a volume flow range, can alternatively or additionally also be considered apart from the system pressure. Furthermore, it can be provided that an operator can predefine defined limit values and therefore the sensitivity for change of the control strategy. Alternatively or additionally, the operator can also predefine a change in the control strategy using an operating and/or display device.

In another preferred embodiment of the method according to the disclosure, the second control strategy is used during one or more acceleration processes, e.g. a calibration, of the distribution machine. During acceleration, several relationships are preferably determined, each with different flow rates, while the set system pressure is particularly preferably at least almost maintained and/or kept constant. This embodiment allows for the necessary adjustment parameters and/or relationships to be ascertained with even greater accuracy.

In addition, it can be provided that the adjustment parameters and/or relationships ascertained and/or determined in the second control strategy, in particular in dependence of the spreading nozzle and/or distribution material, are stored in an electronic data storage device. It can be provided, in particular, that the adjustment parameters and/or relationships can be selected and/or retrieved in dependence of the spreading nozzles and/or distribution materials to be used.

The object underlying the disclosure is further satisfied by an agricultural distribution machine of the kind mentioned at the outset where the distribution machine can be operated with different control strategies for spreading the distribution material, and where the distribution machine, in particular an associated open-loop and/or closed-loop control of system, is configured to change or ignore the controlled variable, which can be adjusted by at least one, in particular central, metering and/or actuating element, based on the control strategies.

The distribution machine for spreading the distribution material can particularly preferably be operated with different control strategies, where the distribution material that can be conveyed along the liquid circuit can be adjusted to the determinable and/or predefineable system pressure in a selectable first control strategy and to the determinable and/or predefineable flow rate in a selectable second closed-loop control mode by way of the at least one metering and/or actuating element.

In a particularly preferred embodiment, the distribution machine, preferably the open-loop and/or closed-loop control system of the distribution machine, is configured to carry out the method for open-loop and/or closed-loop control of an agricultural distribution machine according to one of the embodiments described above. With regard to the advantages and modifications of the distribution machine according to the disclosure, reference is therefore made to the advantages and modifications of the method according to the disclosure.

### BRIEF DESCRIPTION OF THE DRAWINGS

Further details of the disclosure can be gathered from the description of the example and the drawings. The drawings show

FIG. 1 an agricultural distribution machine in a perspective view from behind;

FIG. 2 a schematic embodiment of a liquid circuit according to the disclosure of an agricultural distribution machine.

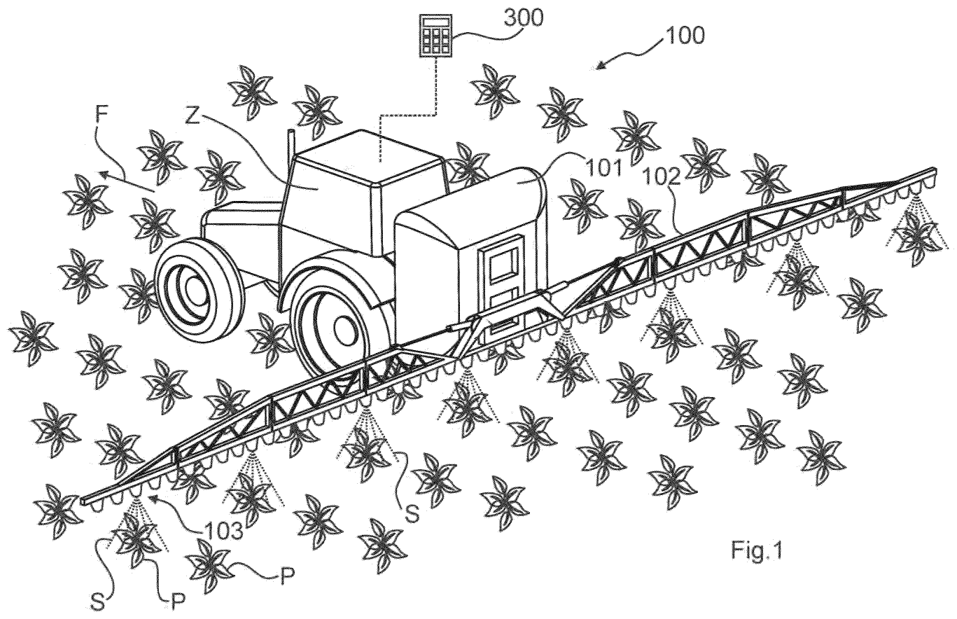

A distribution machine 100 configured as an agricultural field sprayer for spreading a liquid distribution material S, in particular a spray agent, onto an agricultural area and/or a crop population P is shown in FIG. 1. Distribution machine 100 there is carried by a tractor Z. Alternatively, a towed or self-propelled distribution machine 100 would also be conceivable. Furthermore, an alternative to this would also be a distribution machine 100 configured as a sowing and/or fertilizing machine which comprises a spraying device. In addition, a distribution machine 100 which is configured in the manner of a hoe that is carried and/or towed and that comprises a spraying device would also be conceivable.

Distribution machine 100 comprises at least one container 101 for making distribution material S available and at least one spray boom 102 which is aligned to be transverse to a direction of travel F, in particular, is mounted in a pendulum manner and/or is height-guided. Distribution machine 100 also comprises a plurality of spreading nozzles 103 which are connected to container 101 in a fluid-conducting manner and are arranged along spray boom 102. Spreading nozzles 103 are configured to spread and/or apply distribution material S as required and in the form of a spray fan onto the agricultural area and/or the crop population P.

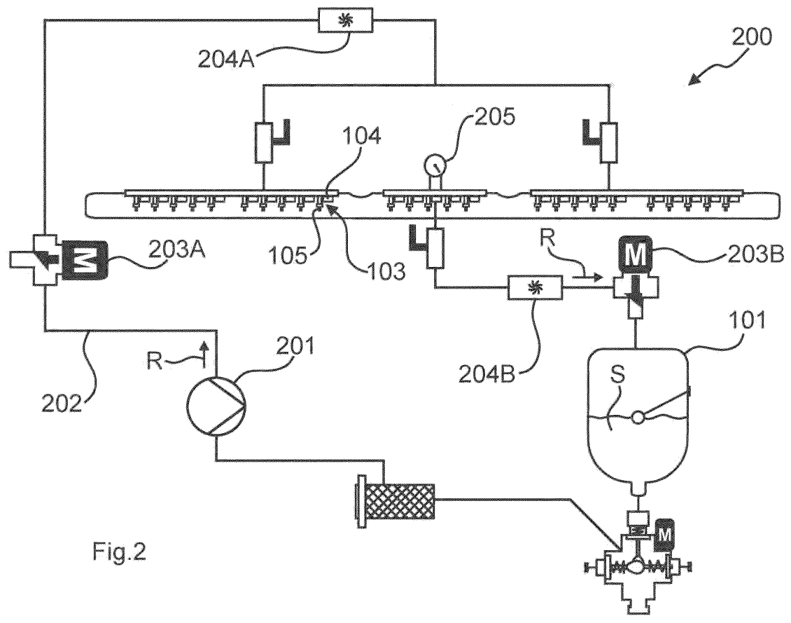

In order to supply and/or provide distribution material S to spreading nozzles 103 as required, distribution machine 100 comprises a liquid circuit 200 within the machine which is shown schematically in a simplified manner in FIG. 2.

As can be seen in, spreading nozzles 103 and container 103 are integrated into liquid circuit 200. In addition to a liquid line 202, liquid circuit 200 also comprises a pump device 201 by way of which distribution material S can be conveyed as required and/or in adjustable quantities along liquid circuit 200. Pump device 201 is, in particular, configured to circulate distribution material S within liquid circuit 200 during the spreading process. For this purpose, liquid line 202 is subdivided into a feed line which is located in a conveying direction R upstream of spreading nozzles 103, and a return line which is located in conveying direction R downstream of spreading nozzles 103. The return line is suitable for returning non-spread or excess distribution material S to container 101. Alternatively, a liquid circuit 200, in particular a liquid line 202, without a return line would also be conceivable.

To spread and/or convey distribution material S, a controlled variable or a system pressure and/or a flow rate for distribution material S is predefined to distribution machine 100 and/or to an open-loop and/or closed-loop control system 300 associated with distribution machine 100. Alternatively or additionally, the controlled variable or the system pressure and/or the flow rate can be retrieved and/or determined by the distribution machine and/or open-loop and/or closed-loop control system 300. It is presently to be explicitly mentioned that the flow rate retrieved and/or predefined can also be determined from a predefineable spreading quantity (quantity of the distribution material on the area to be applied, e.g. in L/ha). Alternatively or additionally, it would further be conceivable that the controlled variable or the system pressure and/or the flow rate, in particular the spreading quantity, can be retrieved in a location- and/or partial area-specific manner from an electronically stored map, for example, an application map. Distribution material S is then conveyed along liquid circuit 200 formed within distribution machine 100 on the basis of the controlled variable or the system pressure and/or the flow rate. Several, in particular central, metering and/or actuating elements 203A, 203B are furthermore arranged along liquid circuit 200 and are configured to adjust the controlled variable or the system pressure or the flow rate of distribution material S conveyed. In this embodiment, a first metering and/or actuating element 203A is arranged in the feed line and a second metering and/or actuating element 203B is arranged in the return line of liquid line 202, where metering and/or actuating elements 203A, 203B are each configured by way of example in the manner of an adjustment valve. As an alternatively, it would also be conceivable for liquid circuit 200 to comprise more than two metering and/or actuating elements 203A, 203B or only one of metering and/or actuating elements 203A, 203B.

According to the disclosure, distribution machine 100, in particular open-loop and/or closed-loop control system 300, can be operated with different control strategies, where the control strategies specify the manner in which the flow of distribution material S along liquid circuit 200 is controlled in an open-loop and/or closed-loop manner. The controlled variable, which is adjusted by at least one, in particular central, metering and/or actuating element, can be switched over or at least substantially ignored based on the control strategies. In the embodiment shown, distribution machine 100 can be operated with a selectable first and second control strategy. In the selectable first control strategy, distribution material S is adjusted or controlled in a closed-loop manner to the determined and/or predefined system pressure by way of, in particular central, metering and/or actuating elements 203A, 203B. In the selectable second control strategy, distribution material S is adjusted or controlled in a closed-loop manner to the determined and/or predefined flow rate by way of, in particular central, metering and/or actuating elements 203A, 203B. The control strategy thus influences an controlled variable of one of several control circuits of distribution machine 100, in particular of open-loop and/or closed-loop control system 300.

In an alternative embodiment to that shown, it would also be conceivable that the controlled variable controlled in a closed-loop manner by way of the, in particular central, metering and/or actuating element is neglected and/or ignored in or during the second control strategy. In this case, it can be provided, for example, that the one or more, in particular central, metering and/or actuating elements are opened to the maximum.

By way of a further closed-loop control circuit of distribution machine 100, in particular of open-loop and/or closed-loop control system 300, which is also influenced by the control strategy, either the system pressure or the flow rate is controlled in an open-loop and/or closed-loop manner or adjusted, in particular in a decentralized manner, by way of metering and/or actuating elements 104 associated with spreading nozzles 103. In particular, it is provided that the flow rate is controlled in an open-loop and/or closed-loop manner or adjusted in the first control strategy and the system pressure in the second control strategy by way of metering and/or actuating elements 104. In other words, a second controlled variable is created by way of metering and/or actuating elements 104 immediately upstream of spreading nozzles 103, in particular of spray nozzles 105, and influences the system pressure and/or the flow rate of material S to be distributed.

In order for a determined, predefined and/or retrieved spreading quantity of distribution material S via spreading nozzles 103 to be adjustable, the necessary adjustment parameters of metering and/or actuating elements 104 must be determined before or during the spreading process.

For this purpose, distribution machine 100 is operated in the second control strategy at least briefly outside or while traveling over the area to be sprayed so that a predefined flow rate of distribution material S, in particular a volume flow, is adjusted by way of, in particular central, metering and/or actuating elements 203A, 203B. To adjust the flow rate, liquid circuit 200 furthermore comprises one or more measuring devices 204A, 204B which are configured to detect and/or determine the flow rate, in particular the volume flow, of distribution material S through liquid circuit 200. Measuring devices 204A, 204B shown are there configured by way of example as volume flow sensors, although other types of sensors would also be conceivable as an alternative.

While the flow rate is adjusted by way of metering and/or actuating elements 203A, 203B, the system pressure is adjusted by way of metering and/or actuating elements 104 of spreading nozzles 103. To adjust the system pressure, liquid circuit 200 furthermore comprises one or more pressure detection devices 205 which are configured to detect and/or determine the system pressure of distribution material S within liquid circuit 200, in particular in the region and/or immediately upstream of spreading nozzles 103. Pressure detection device 205 shown is configured, for example, as a pressure sensor and/or as an electronic manometer. Alternatively, other types of sensors that are suitable for detecting and/or determining a liquid pressure would also be conceivable.

When spreading distribution material S in the second control strategy, the valve-specific adjustment parameters of metering and/or actuating elements 104 are determined and/or detected or recorded, respectively. The adjustment parameters can there differ in dependence of the system pressure.

Furthermore, one or more relationships related to the respective, in particular adjusted, system pressure between the respective, in particular centrally, adjusted flow rate and the respective, in particular valve-specific, adjustment parameters are determined. It is provided, in particular, that the one or more relationships are determined for each spreading nozzle 103 based on the flow rate and the number of spreading nozzles 103, for example, nozzle by nozzle and/or individually. The, in particular adjusted and/or detected, flow rate is allocated among the number, in particular opened, spreading nozzles 103 so that the actual spreading quantity via the individual spreading nozzles 103 is ascertained based on the centrally detected flow rate. In other words, the flow rate that is actually spread is standardized to the individual or a single spreading nozzle 103.

Once the respective relationships and/or adjustment parameters have been determined and/or ascertained in the first control strategy, the control strategy of distribution machine 100, in particular of the open-loop and/or closed-loop control system 300, for spreading the distribution material is switched over to the first control strategy and/or changed. While the system pressure is then adjusted, in particular centrally, by way of one or more metering and/or actuating elements 203A, 203B, metering and/or actuating elements 104, in particular spreading quantities, are adjusted in dependence of and/or on the basis of the one or more relationships and/or adjustment parameters determined in the second control strategy. The advantage there is that information and/or properties of metering and/or actuating elements 104 and/or spreading nozzles 103, in particular valve- and/or nozzle-specific information, can be neglected or does not have to be predefined. Such information and/or properties can be, for example, the type, nozzle size, in particular the nozzle caliber, manufacturing tolerances, and/or the state of wear of a spreading nozzle 103, in particular of a spray nozzle 105. The properties of the distribution material, such as the viscosity etc. of the spray liquid, can also be neglected.

Spreading nozzles 103 shown in the figures each comprise a nozzle body or a nozzle holder on which a spray nozzle 105 and associated metering and/or actuating element 104 are arranged. In an alternative embodiment, spreading nozzle 103 can also be configured, for example, in the manner of a multiple nozzle body with several, in particular different spray nozzles 105 and/or metering and/or actuating elements 104. Furthermore, it would be conceivable to be able to switch between different spray nozzles 105 of a multiple nozzle body or that several spray nozzles 105 of a multiple nozzle body can be activated or opened to dispense distribution material S. Metering and/or actuating elements 104 shown are configured in the manner of valves, in particular spray nozzle valves. It is provided there, in particular, that metering and/or actuating elements 104 are configured in the manner of PWM and/or PWFM valves and are configured to release distribution material S in a pulse width modulated manner. In the case of PWM and/or PWFM valves, at least one adjustment parameter can be configured as a pulse width and/or pulse frequency, in particular as a duty cycle.

The method according to the disclosure can be used for different purposes and/or situations during the spreading process. For example, it can be provided that the control strategy of distribution machine 100, in particular of the open-loop and/or closed-loop control system 300 is changed for the conveyed distribution material following a change in the operating state of distribution machine 100 and/or an exceedance or undershot of defined flow values, for example, a limit value for the system pressure. In particular, if the conditions and/or adjustment parameters necessary for the intended spreading, in particular, an adapted system pressure and/or an adapted flow rate of distribution material S are not present in the first control strategy, it can be provided to switch the control strategy at least temporarily over to the second control strategy for determining and/or ascertaining the necessary relationships and/or adjustment parameters.

A change in the operating state can be effected, for example, by switching spreading nozzles 103 over or switching them on or off, changing the distribution material or the distribution material composition, or adapting the intended travel speed ranges. Furthermore, an adjustment of the control strategy can be provided when the system pressure with which distribution material S is to be spread in the first control strategy is adapted.

In addition, it can be provided that the second control strategy is applied during one or more acceleration processes, e.g. a calibration of distribution machine 100. During acceleration, several relationships and/or adjustment parameters for different flow rates can then be determined, in particular, when the system pressure remains at least almost constant.

The desired and/or intended system pressure is predefined manually by an operator, e.g. in dependence of environmental conditions, of the needs of the crop, and/or of a desired droplet size. Alternatively, the system pressure can also be determined and/or retrieved in an automated manner. Furthermore, it can be provided that the desired spreading quantity, e.g. in liters per hectare, is predefined by the operator or alternatively or additionally by way of an electronically stored application map. The flow rate of distribution material S can then be determined based on the desired spreading quantity.

It is to be understood that the method according to the disclosure in the previously described embodiment is described based on only one liquid circuit 200 formed in distribution machine 100, where the method can also be applied to a distribution machine 100 with several, in particular parallel, liquid circuits 200. Several individual liquid circuits 200 can then be provided for different distribution materials S, in particular for different spray liquids or carrier liquids and/or active ingredient liquids.

It would also be conceivable to apply the method according to the disclosure to a distribution machine 100 which, in addition to liquid distribution materials S, can also spread granular distribution materials, such as sowing and/or fertilizer machines.

It is also understood that the features mentioned in the previously described embodiments are not restricted to these specific combinations and are also possible in any other combination. Furthermore, it goes without saying that the geometries shown in the figures are only by way of example and are also possible in any other configuration.

### LIST OF REFERENCE CHARACTERS

100 distribution machine
101 container
102 spraying boom
103 spreading nozzles
104 metering and/or switching elements
105 spray nozzles
200 liquid circuit
201 pump device
202 liquid line
203a, 203b metering and/or actuating elements 204a, 204b measuring devices 205 pressure detection device
300 open-loop and/or closed-loop control system
F direction of travel
P plant population
R conveying direction
S distribution material
Z tractor

1. A method for control of an agricultural distribution machine, in particular a field sprayer, when spreading liquid distribution material, with the step of:
determining or predefining at least one controlled variable, including a system pressure or a flow rate, for said distribution material, on the basis of which said distribution material is conveyed at least in sections along a liquid circuit formed within said distribution machine, wherein the controlled variable, in particular the system pressure or the flow rate, is adjusted by way of at least one, in particular central, metering and/or actuating element arranged along said liquid circuit,
wherein said agricultural distribution machine can be operated with different control strategies, wherein the controlled variable, which is adjusted by said at least one, in particular central, metering and/or actuating element is switched or at least substantially ignored based on said control strategies.

2. The method according to claim 1, wherein said distribution material conveyed along said liquid circuit is adjusted to the determined and/or predefined system pressure in a selectable first control strategy and to the determined and/or predefined flow rate in a selectable second control strategy by way of said at least one, in particular central, metering and/or actuating element.

3. The method according to claim 2, further including:
determining and/or predefining a spreading quantity with which said distribution material is spread, preferably as needed and/or nozzle by nozzle, via spreading nozzles, in particular spray nozzles, which are arranged on a spray boom of said distribution machine;
wherein one or more metering and/or actuating elements are associated with several or each of said spreading nozzles, by way of which the flow rate is controlled in an open-loop or closed-loop manner in the first control strategy and the system pressure is controlled in an open-loop or closed-loop manner in the second control strategy.

4. The method according to claim 3, further comprising at least one of the following steps:
detecting the flow rate by way of at least one measuring device, which is arranged along said liquid circuit;
determining and/or detecting, in particular valve-specific, adjustment parameters, which are adjusted in the second control strategy in dependence of the system pressure at the respective metering and/or actuating elements, or
determining one or more relationships related to the system pressure between the flow rate and the respective, in particular valve-specific, adjustment parameters.

5. The method according to claim 3, wherein the one or more relationships are determined based on the flow rate and the number of spreading nozzles.

6. The method according to claim 3, wherein said metering and/or actuating elements, in particular said spreading quantities, are adjusted in the first control strategy in dependence of and/or on the basis of the one or more relationships determined in the second control strategy.

7. The method according to claim 3, wherein said metering and/or actuating elements are configured to release said distribution material in a pulse width modulated manner, wherein at least one adjustment parameter of said metering and/or actuating elements is configured as a pulse width and/or pulse frequency, preferably as a duty cycle.

8. The method according to claim 1, wherein the control strategy of said distribution machine is changed, once or several times before and/or during the spreading process of said distribution material from the first control strategy to the second control strategy.

9. The method according to claim 8, wherein the control strategy is changed for said conveyed distribution material following a change in the operating state of said distribution machine and/or an exceedance or undershot of defined flow values, for example a limit value for the system pressure.

10. The method according to claim 2, wherein the second control strategy is applied during one or more acceleration processes, wherein several relationships with different flow rates are determined during the acceleration.

11. A field sprayer for spreading liquid distribution material, preferably spraying agent, comprising:
at least one liquid circuit along which said distribution material can be conveyed from at least one container to a plurality of spreading nozzles, in particular spray nozzles, wherein said spreading of nozzles are configured to spread said distribution material, in particular nozzle-by-nozzle and/or in a partial area-specific manner, at a determinable and/or predefineable spreading quantity; and
at least one metering and/or actuating element arranged along said liquid circuit and configured to adjust a determinable and/or predefineable controlled variable, in particular a system pressure or a flow rate, for said distribution material conveyed along said liquid circuit; wherein said distribution machine for spreading said spreading material can be operated with different control strategies, wherein said distribution machine, in particular an associated open-loop and/or closed-loop control of system is configured to switch or at least to substantially ignore the controlled variable, which can be adjusted by at least one, in particular central, metering and/or actuating element, based on the control strategies.

12. (canceled)

13. The method of claim 10, wherein the acceleration process is calibration, of said distribution machine.
